(19) United States
(12) Patent Application Publication
(10) Pub. No.: US 2020/0398237 A1
(43) Pub. Date: Dec. 24, 2020

(54) PARTICULATE COLLECTOR FOR DRUMS

(71) Applicant: Beaton Innovations, Inc., West Elmira, NY (US)

(72) Inventor: Joel S Beaton, West Elmira, NY (US)

(21) Appl. No.: 16/448,828

(22) Filed: Jun. 21, 2019

(51) Int. Cl. B01F 15/00; B01F 3/18

(52) U.S. Cl. CPC B01F 15/00961; B01F 3/18

(57) ABSTRACT

Collector for attachment to a vacuum cleaner to collect particulates spilling out of a drum during mixing.

### BACKGROUND OF THE INVENTION

### Field of the Invention

The invention pertains to the field of particulate collectors. More particularly, the invention pertains to a particulate collector for drums.

### Description of Related Art

In many facilities, powders are mixed together to form a powdery compound product which are either sold outright or are further processed by mixing the powdery compound with other products. This mixing often needs to occur within a hood or a specialized area within the facility due to the particulates that end up in the air during the mixing of powders. The problems that can arise during the mixing process of powders in large volumes include, when the powder is poured into a container, for example drums, the powder particulates billow out and create a mess. The powder particulates can also be harmful if breathed in by users preparing the powdery compounds. Additionally, when the powders or the powdery compound are mixed together, additional particulates are created during the process.

FIGS. 32-38 show a conventional particulate collector 400 of U.S. Published Application No. 2014/0115821. The particulate collector 400 has a crescent shaped body with curved outer ends 425, an outer surface 423 and an inner surface 424, vacuum ports 437, 438 extend from the outer surface 423 to the inner surface 424, and a collection chamber 431 formed adjacent the outer surface 423. A hollow pipe 402 with an outer end is connected to an opening 401 in the collection chamber 431. The hollow pipe 402 is connected to a bottom of the 426 of the collection chamber 431. The hollow pipe 402 is preferably at a 20 degree angle relative to the bottom 426 of the collection chamber 431. The collection chamber 431 is connected to an inner chamber 430 through the vacuum ports 437, 438.

The inner chamber 430 of the particulate collector 400 is defined between an upper protruding rim 421, an inner surface 424, and a lower protruding rim 422. The upper protruding rim 421 and the lower protruding rim 422 are semicircular shaped and preferably corresponds to the shape of an outer lip along the rim of a drum with the back end of the particulate collector extending out from the drum. Vacuum ports 437, 438 allow air to flow from the inner chamber 430 and into the collection chamber 431. The outer ends 425 of the particulate collector 400 are curved outward to aid in maintaining contact between the drum 60 and the particulate collector 400 through friction. At opposing ends of the particulate collector 400 are slots 432, 434. The slots 432, 434 define an opening 435, 436 to allow movement of clips within the slots 432, 434.

Some of the disadvantages associated with the conventional particulate collector are the angle of the pipe 402 relative to the collection chamber 431 limits the airflow and does not capture the particulates in the drum.

### SUMMARY OF THE INVENTION

A particulate collector for attachment to a vacuum cleaner and for preventing particulates from spilling over a top of an opening defined by a rim with an outer lip during mixing of material in a drum. The collector comprises a body, a hollow pipe for connection to the body and vacuum hose and a funnel shield. The body of the particulate collector has opposing curved ends, a top portion extending to an upper rim and a bottom portion extended to a lower rim, and an inner wall surface having at least three ports. The top portion, bottom portion and inner wall surface define a first chamber and the lower rim, upper rim and inner wall surface define a second chamber, with the first chamber being connected to the second chamber through the at least three ports of the inner wall surface. The hollow pipe has a tubular body with an outer end for attachment to a vacuum cleaner and an inner end mounted to the body, in communication with the first chamber via a port. The funnel shield is mounted to the top portion of the body, extending beyond the upper rim and the lower rim of the body, the funnel shield having a funnel body with a top surface, a bottom surface, and curved outer ends, the bottom surface of the funnel shield body and the top surface of the body defining at least one angled passage.

When the body of the particulate collector is placed in the opening of the drum and rests on the rim of the opening, with a vacuum cleaner connected to the outer end of the hollow pipe, particulates which are present in the opening of the drum are sucked into the vacuum cleaner.

### BRIEF DESCRIPTION OF THE DRAWING

FIG. 1 shows a lower perspective view of a particulate collector.

FIG. 2 shows an upper perspective view of the particulate collector.

FIG. 3 shows a top down partial cutaway view of the particulate collector.

FIG. 4 shows a front view of the particulate collector.

FIG. 5 shows a sectional view of the particulate collector along line 5-5 of FIG. 3.

FIG. 6 shows another sectional view of the particulate collector.

FIG. 7 shows a sectional view of the particulate collector along line 7-7 of FIG. 6.

FIG. 8 shows a perspective sectional view of the particulate collector.

FIG. 9 shows a sectional view of the particulate collector along line 9-9 of FIG. 3.

FIG. 10 shows another top down partial cutaway view of the particulate collector.

FIG. 11 shows a sectional view along line 11-11 of FIG. 10.

FIG. 12 shows a back view of the particulate collector.

FIG. 13 shows another sectional view of the particulate collector.

FIG. 14 shows a detailed view of detail B of FIG. 13.

FIG. 15 shows a sectional view of the particulate collector along line 15-15 of FIG. 10.

FIG. 16 shows a top perspective cutaway of the particulate collector.

FIG. 17 shows a side view of the particulate collector.

FIG. 18 shows a top view of the particulate collector.

FIG. 19 shows perspective view of the particulate collector engaged with a drum.

FIG. 20 shows a side view of the particulate collector in the drum.

FIG. 21 shows a top down view of the particulate collector engaged with the drum.

FIG. 22 shows an alternate top down view of the particulate collector engaged with the drum.

FIG. 23 shows top down perspective view of the particulate collector engaged with the drum.

FIG. 24 shows a close-up view of the particulate collection with the drum.

FIG. 25 shows the particulate collection with the drum.

FIG. 26 shows a bottom top view of a left hand clip for securing the particulate collector to the drum.

FIG. 27 shows another view of a clip for securing the particulate collector to the drum.

FIG. 28 shows a side view of a clip for securing the particulate collector to the drum.

FIG. 29 shows another side view of a clip for securing the particulate collector to the drum.

FIG. 30 shows a bottom top view of a right hand clip for securing the particulate collector to the drum.

FIG. 31 shows a schematic of a clip for securing the particulate collector to the drum.

FIG. 32 shows a top down view of a conventional particulate collector.

FIG. 33 shows a section of the conventional particulate collector along line D-D of FIG. 32.

FIG. 34 shows side view of a conventional particulate collector.

FIG. 35 shows a schematic of a conventional particulate collector.

FIG. 36 shows a section of the conventional particulate collector along line E-E of FIG. 32.

FIG. 37 shows a detailed view of a conventional particulate collector point B as shown in FIG. 36.

FIG. 38 shows a section of a conventional particulate collector along line A-A of FIG. 32.

### DETAILED DESCRIPTION OF THE INVENTION

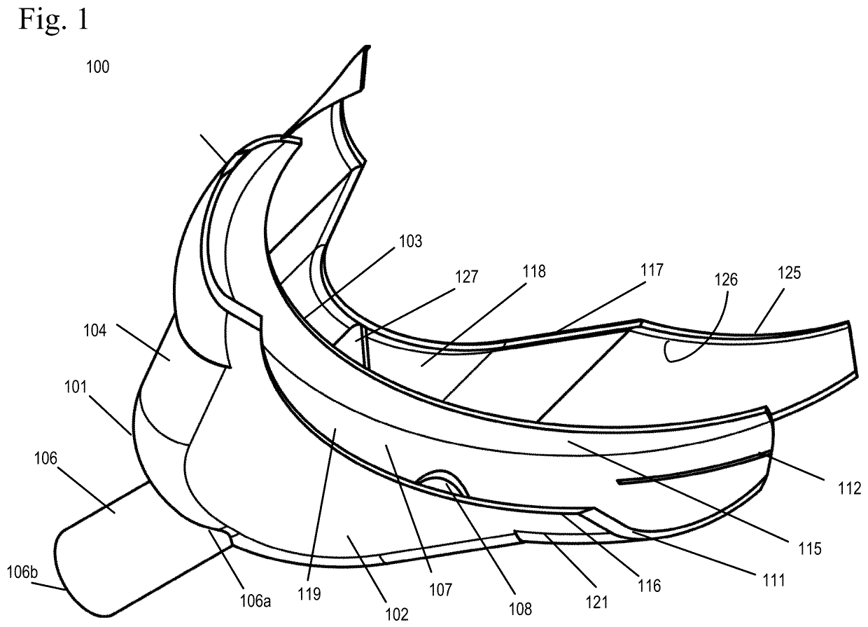

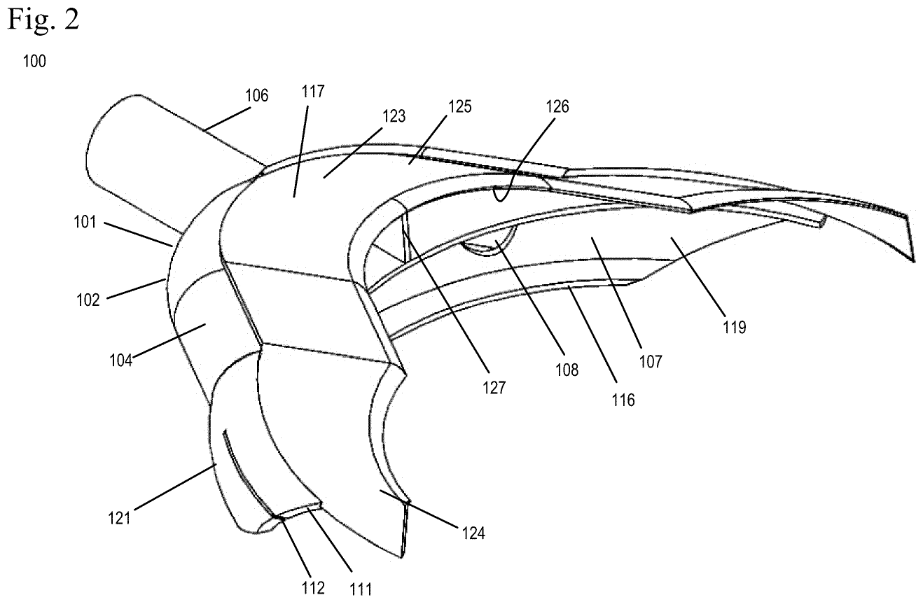

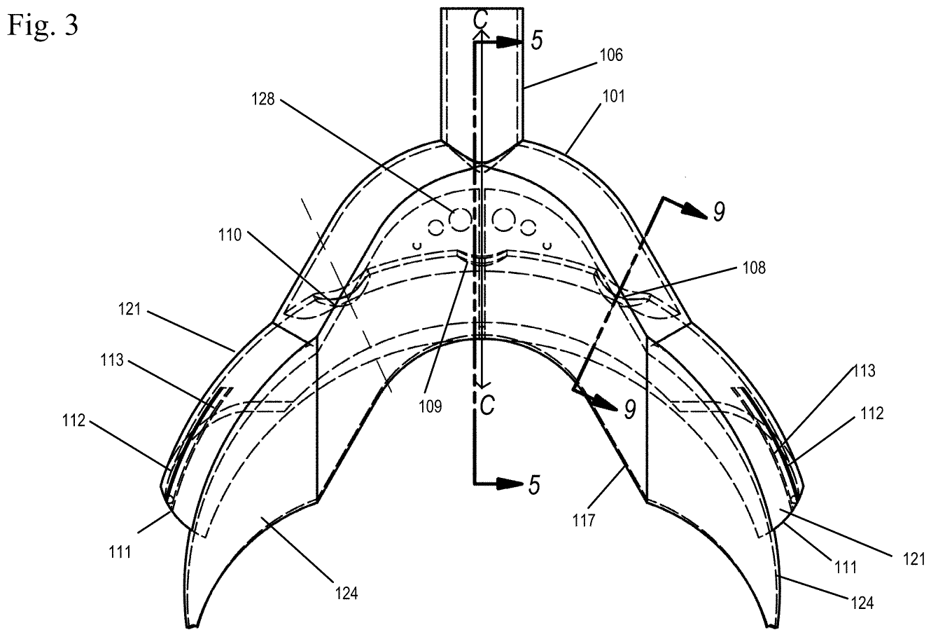

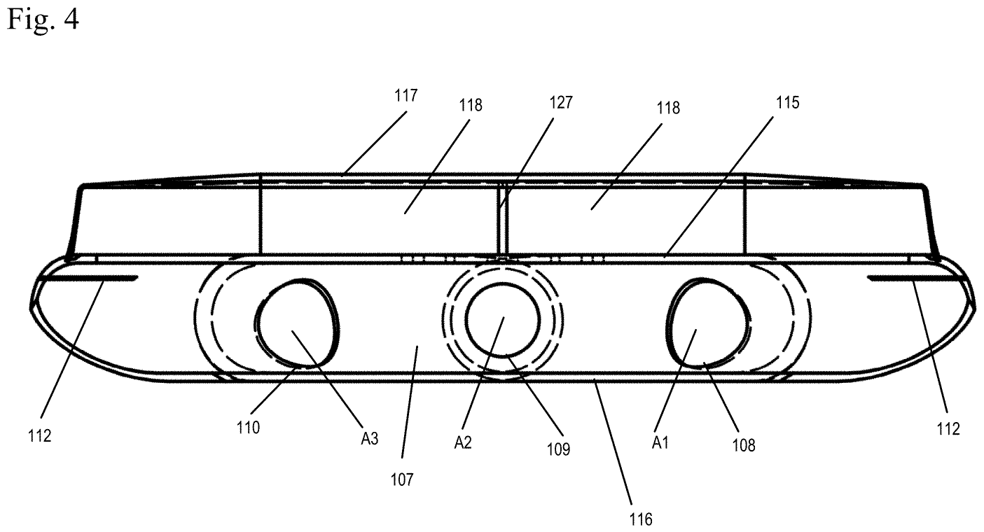

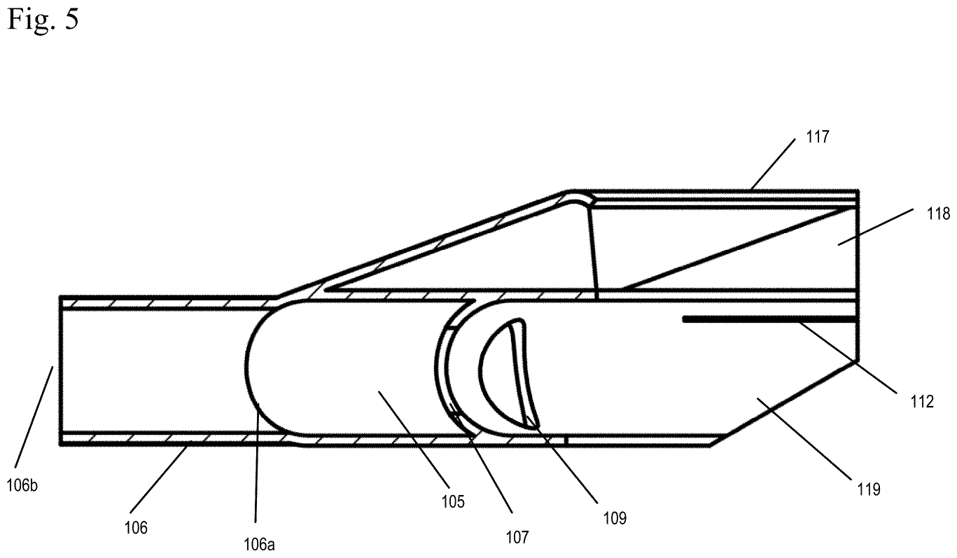

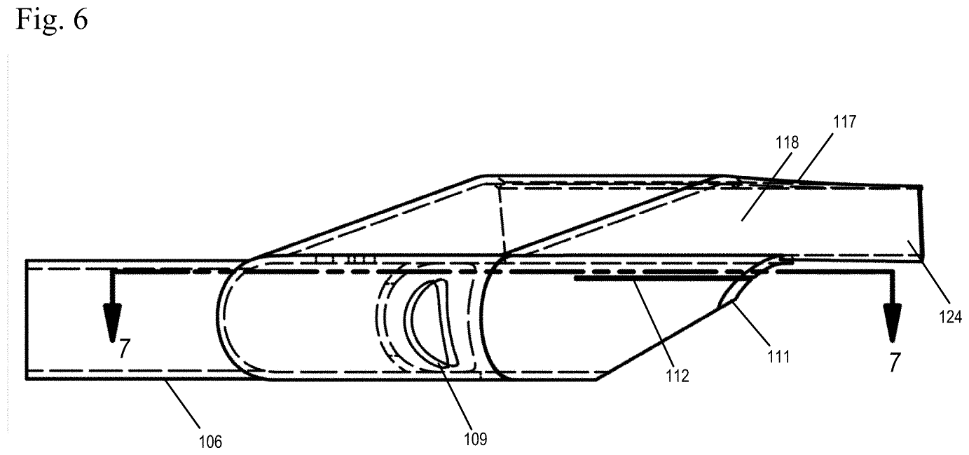

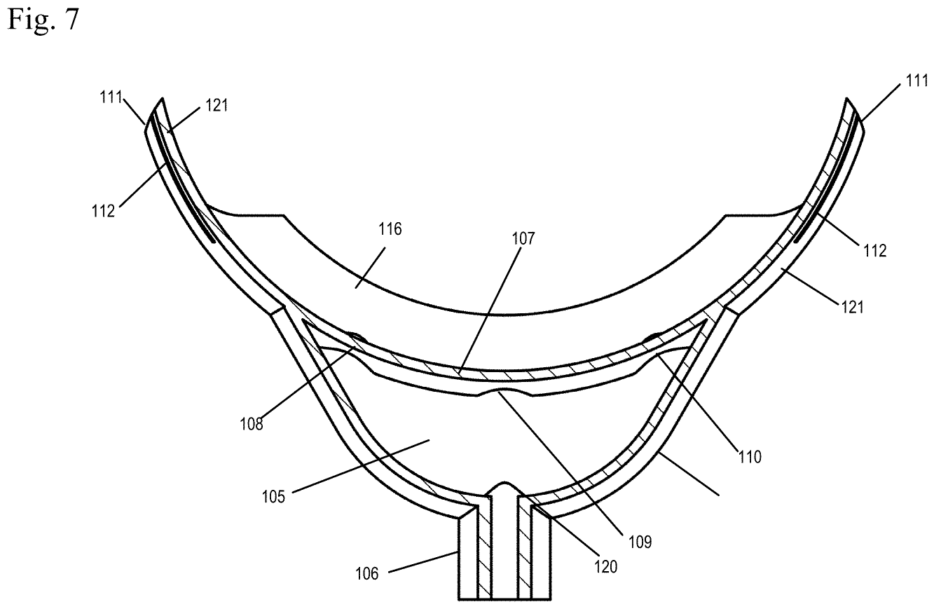

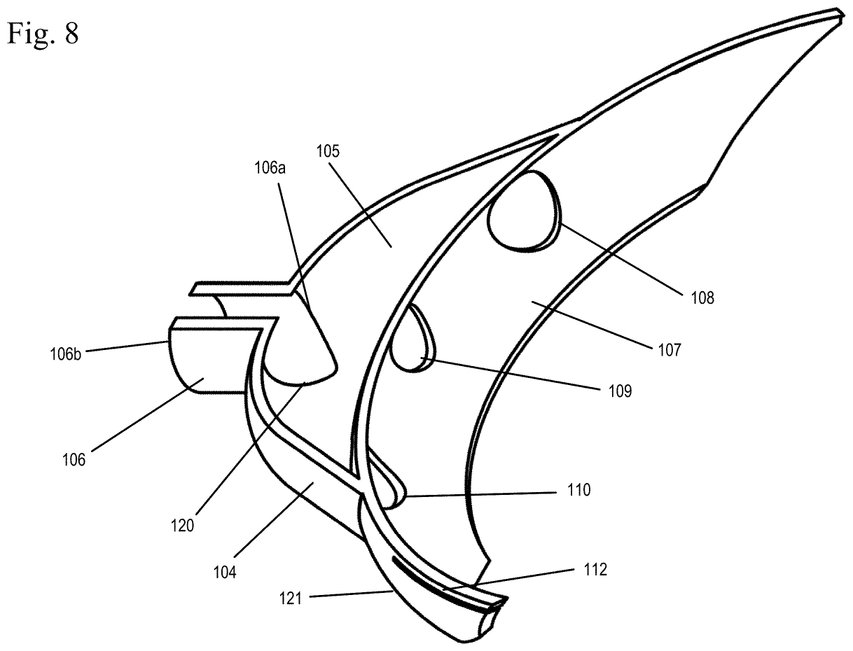

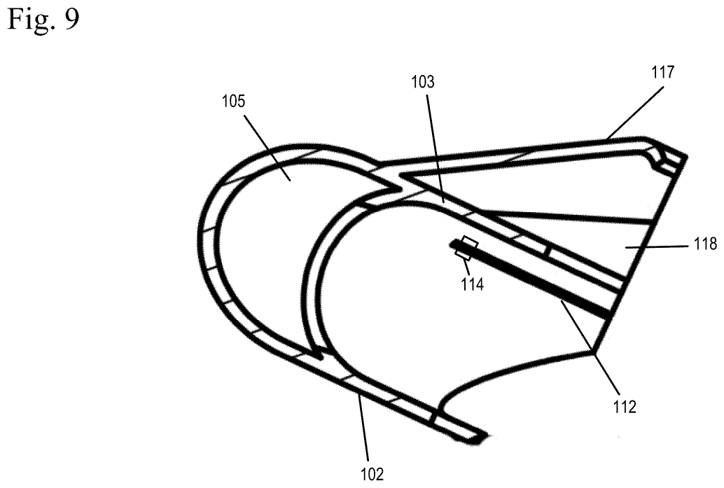

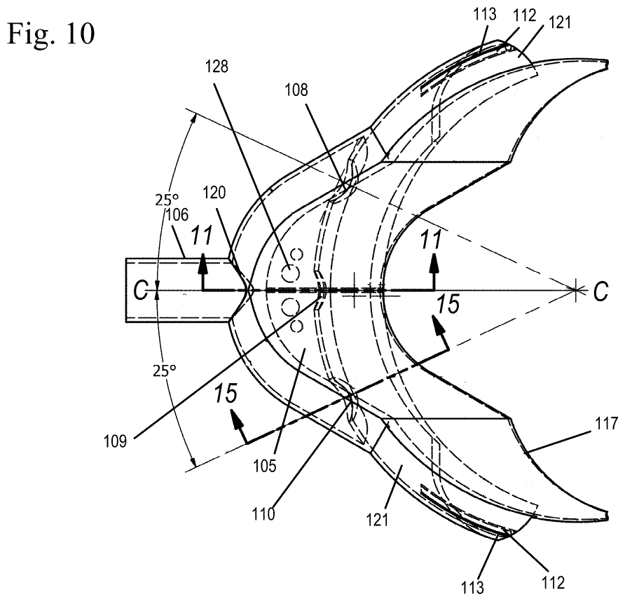

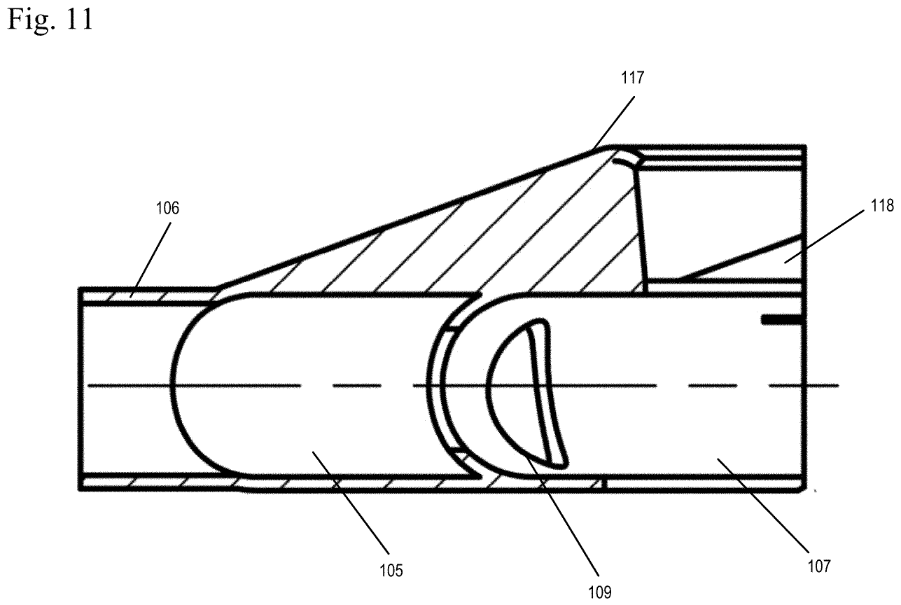

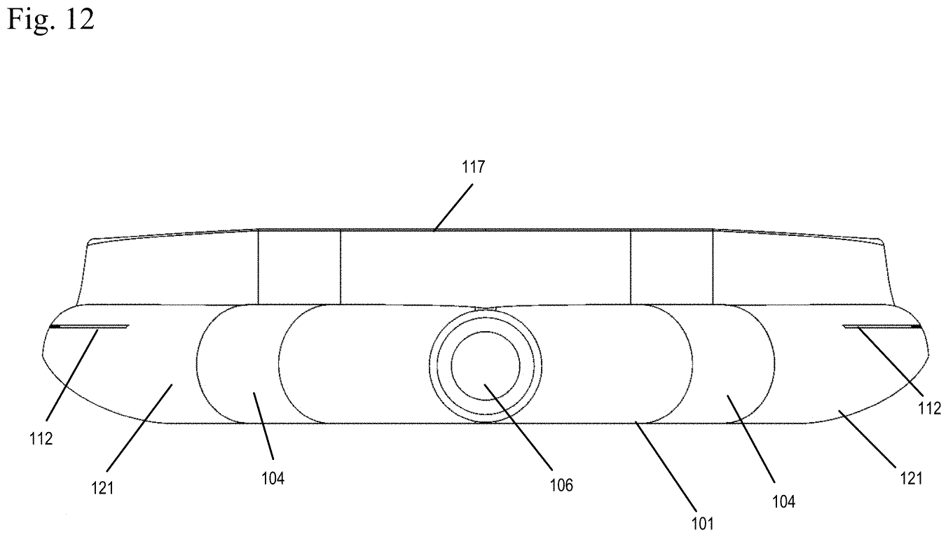

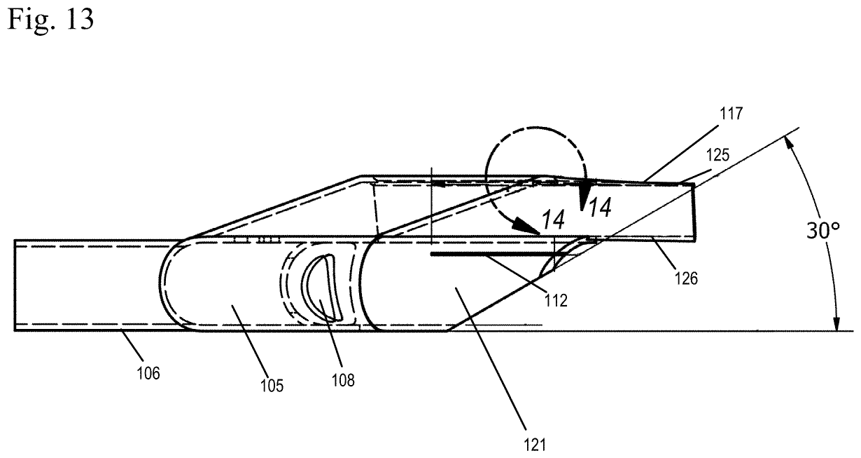

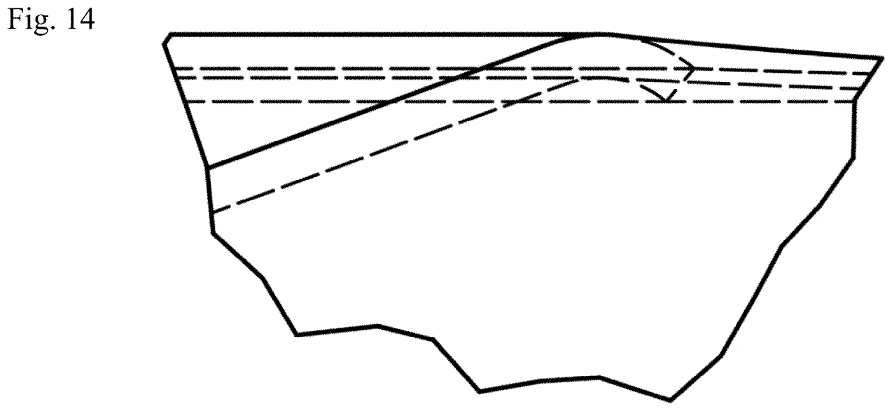

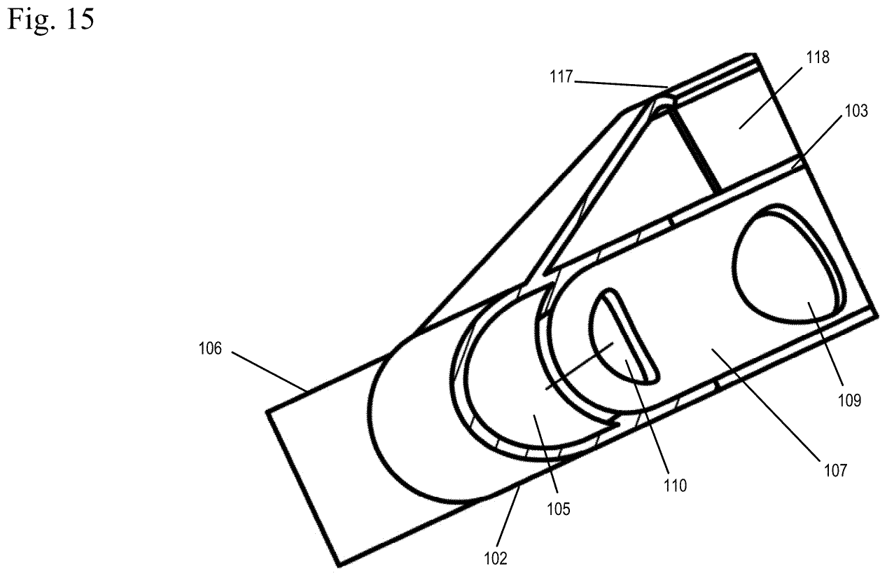

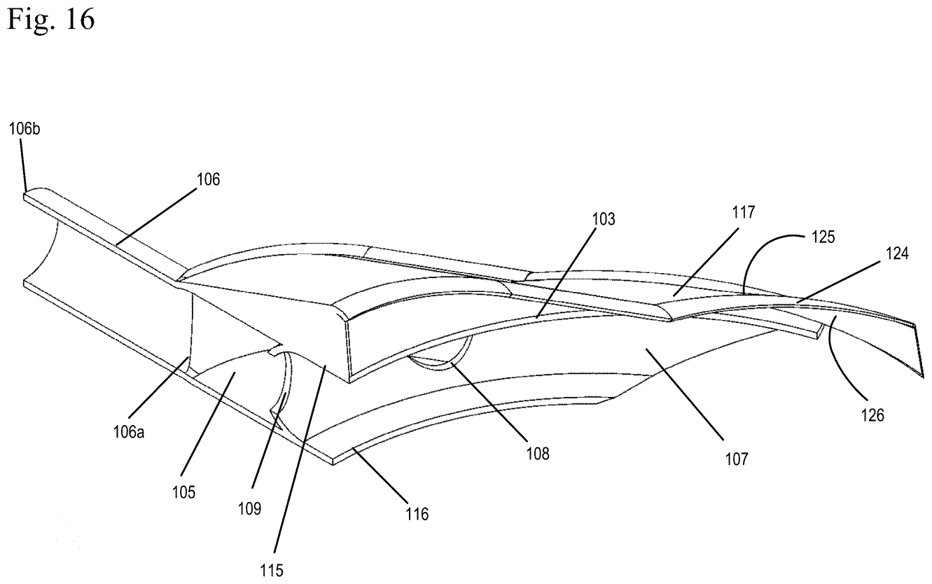

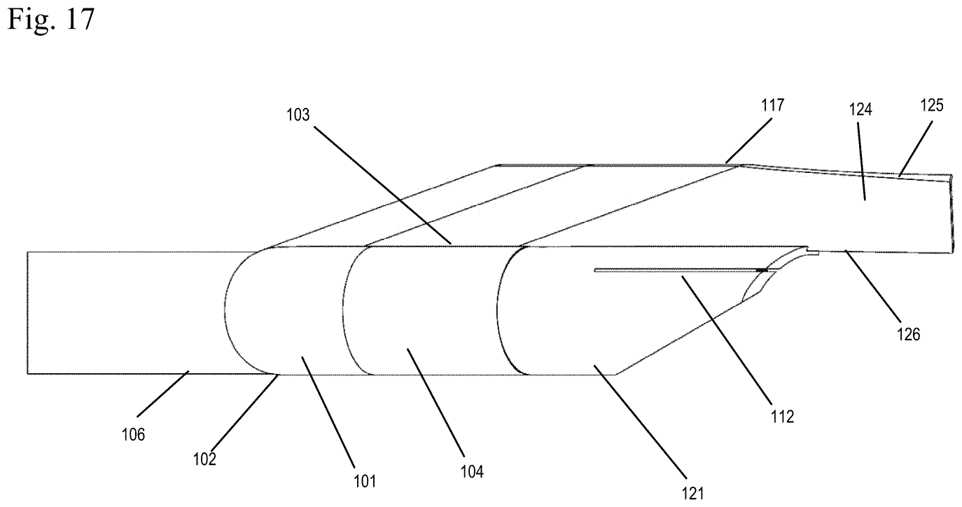

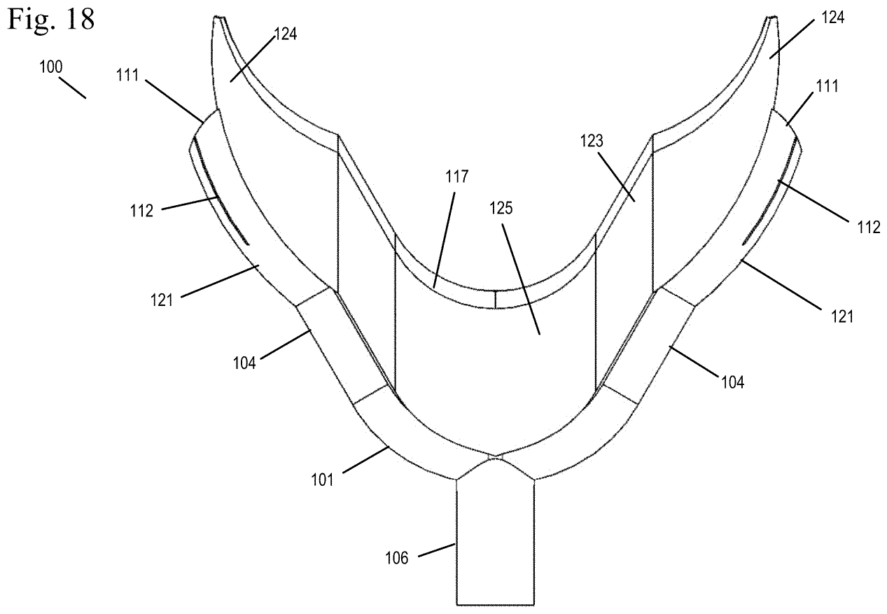

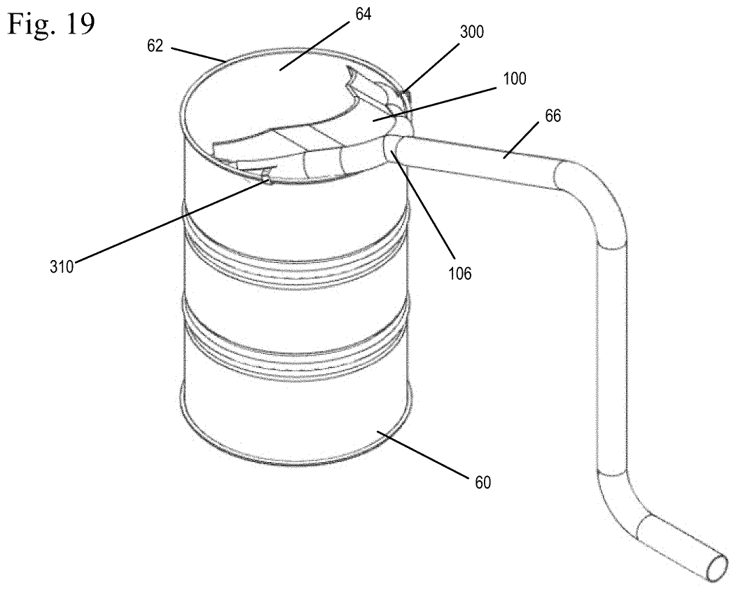

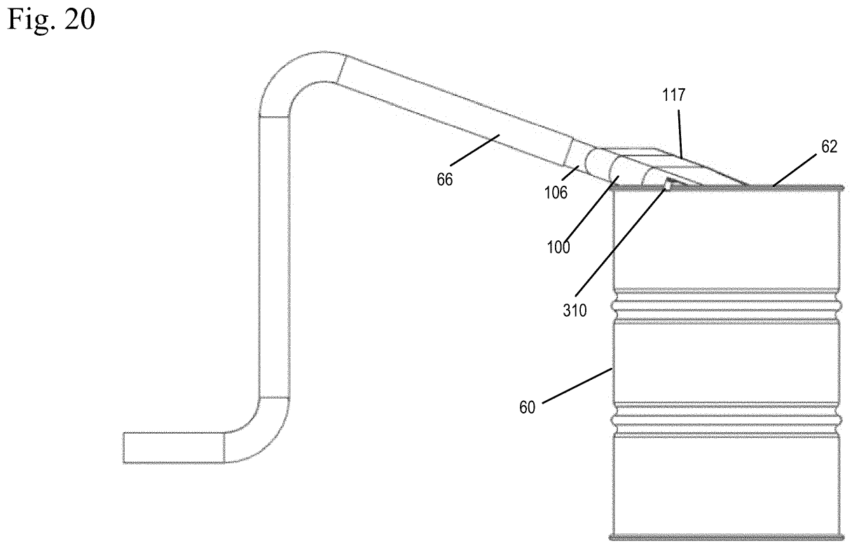

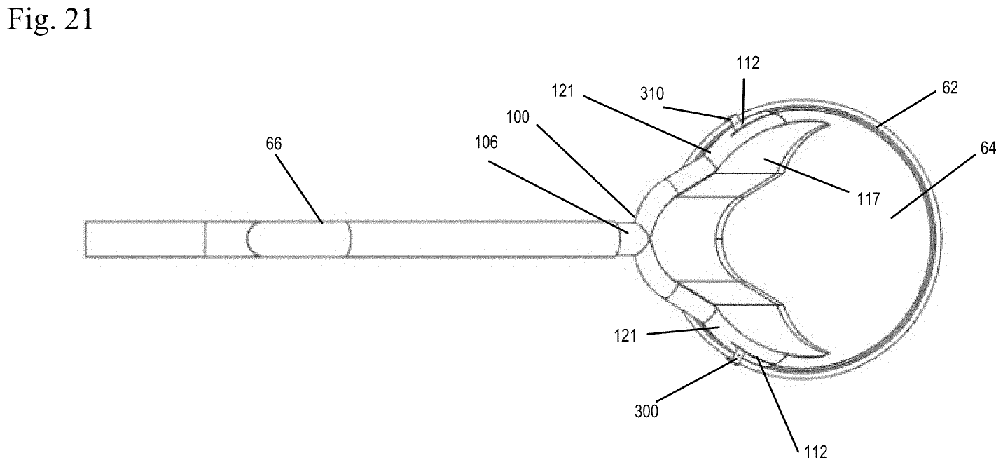

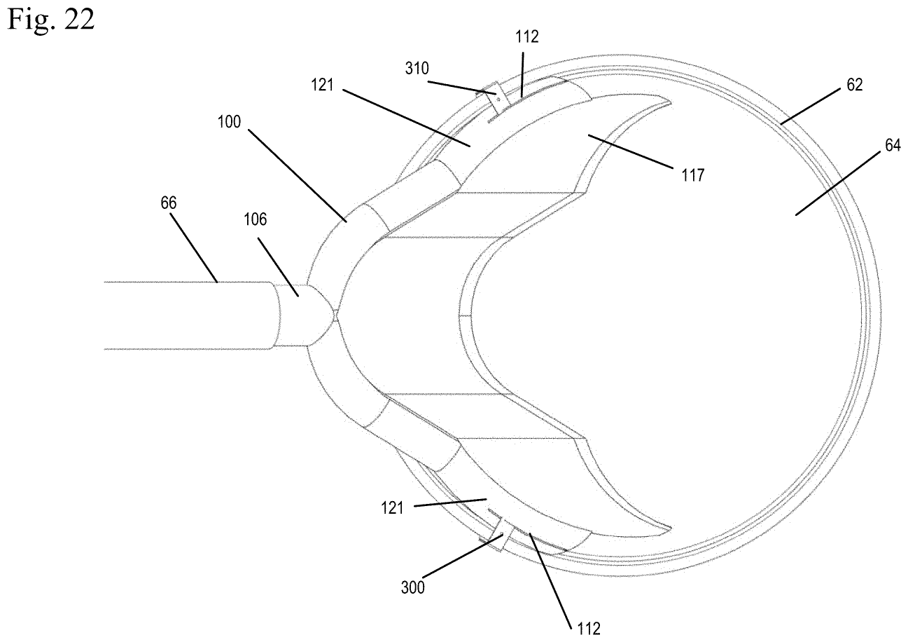

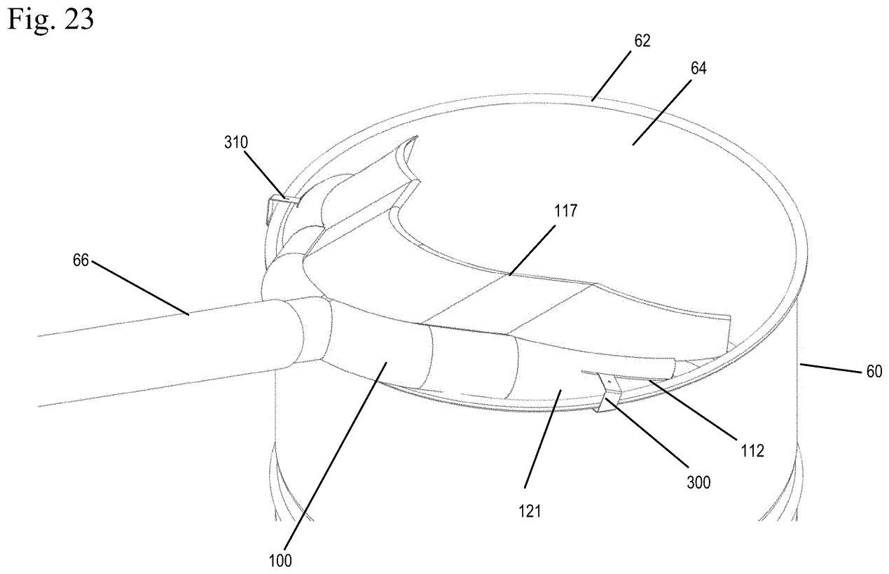

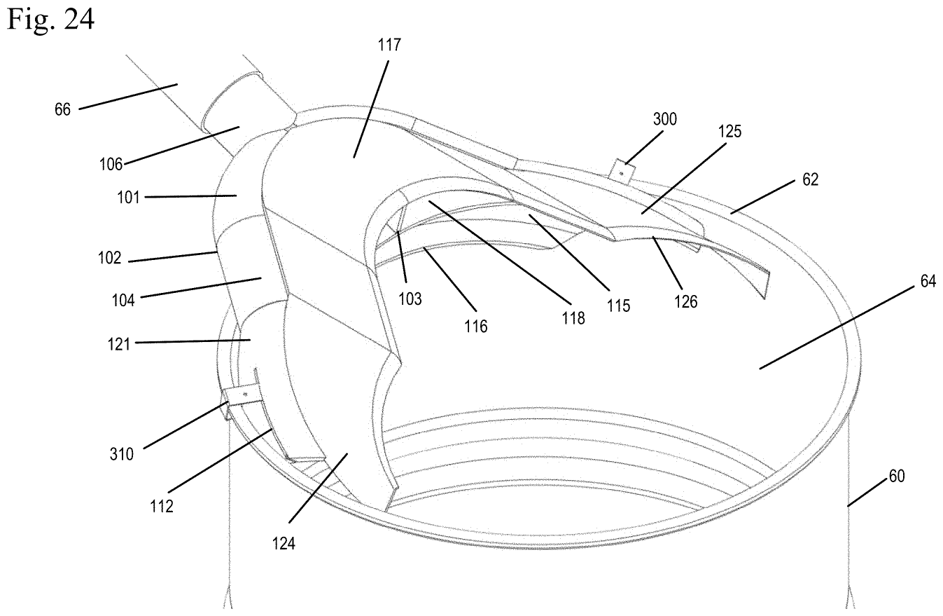

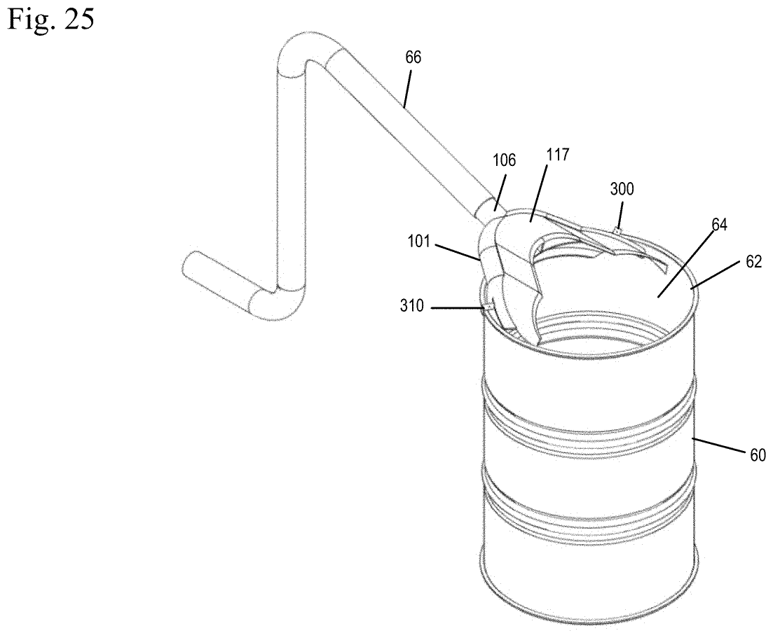

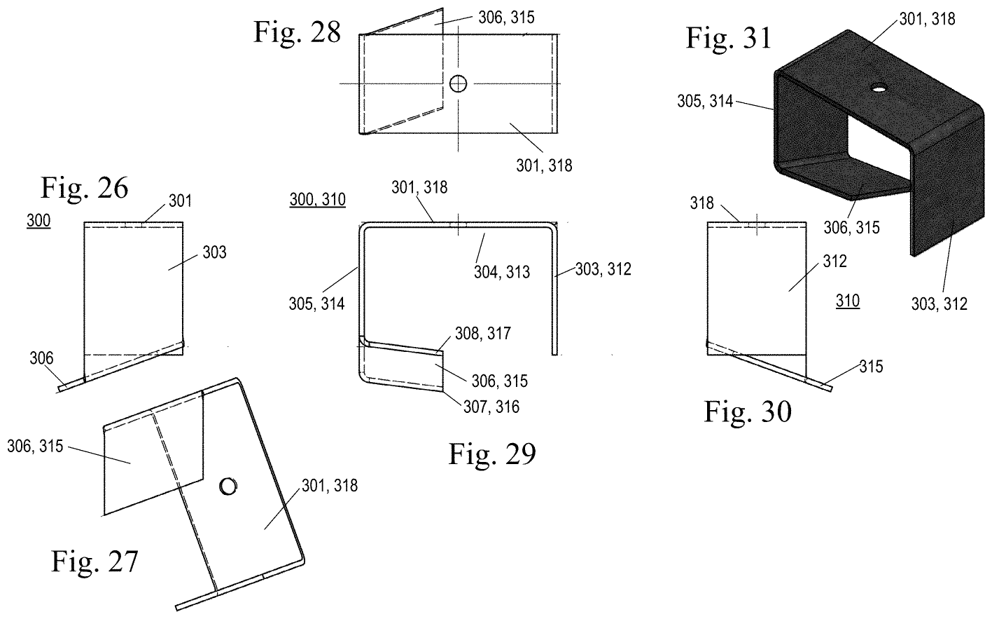

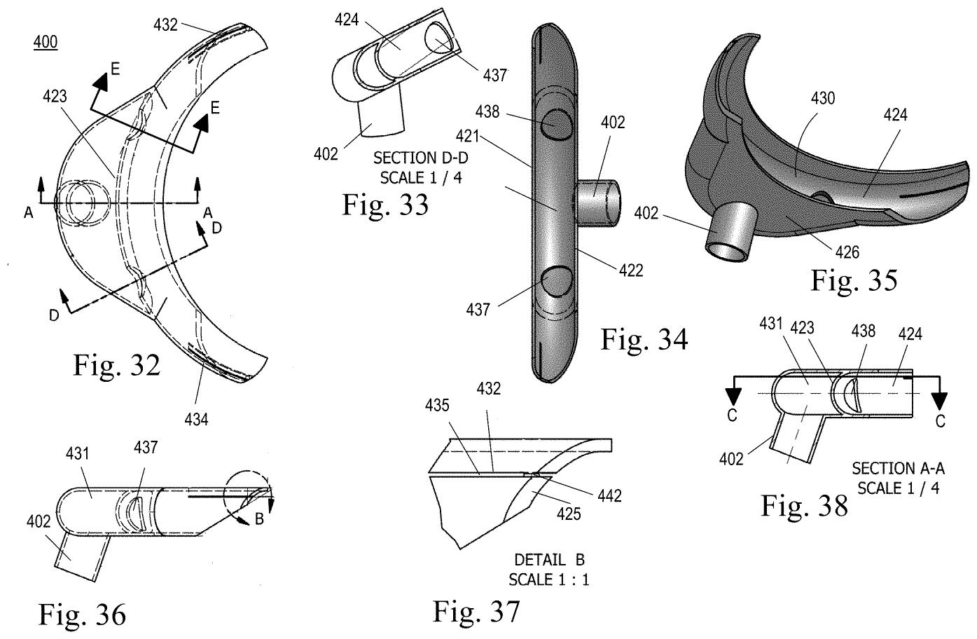

FIGS. 1-18 show a particulate collector 100 of an embodiment of the present invention, FIGS. 26-31 show clips used to secure the particulate collector to a drum and FIGS. 19-25 show the particulate collector 100 engaging a drum. The drum 60 preferably has a capacity of 15 gallons or more. The drum 60 has an outer lip 62 along the rim of the drum 60 surrounding an opening 64.

The particulate collector 100 has a semielliptical or crescent shaped body 101 with a funneling shield 117. The semielliptical body 101 has a top portion 103 connected to a bottom portion 102 through C-shaped sides 104. Between the top portion 103 and the bottom portion 102 is an inner surface wall 107 containing vacuum ports 108, 109, 110. The area A1, A2, A3 of the openings of the vacuum ports 108, 109, 110 can be the same or can vary in size between the ports. The top portion 103, bottom portion 102, inner surface wall 107, and a C-shaped sides 104 define a first chamber 105, referred to as a collection chamber. While three vacuum ports 108, 109, 110 are shown, the number of ports may be increased or decreased. The collection chamber 105 is also in communication with a first end 106a of a hollow pipe 106 through an opening 120 on the C-shaped sides 104 at a back of the semielliptical or crescent shaped body 101, opposite the inner surface wall 107. The second end 106b of the hollow pipe 106 is attached to a vacuum hose 66 during use of the particulate collector 100. The hollow pipe 106 may be integrally formed with the semielliptical or crescent shaped body 101 of the particulate collector 100 or secured through other means. The hollow pipe 106 is preferably connected to semielliptical or crescent shaped body 101 of the particulate collector 100 along a centerline C-C. The hollow pipe 106 can be attached to the bottom portion 102 of the particulate collector 100. The hollow pipe 106 can also be connected at an angle relative to the semielliptical or crescent shaped body 101 of the particulate collector 100.

The collection chamber 105 is additionally in communication with a funnel passage 118 through a series of holes 128. The area of the series of holes 128 is equal to the area A1, A2, A3 of at least one of the openings of a vacuum port 108, or vacuum port 109, or vacuum port 110.

The top and bottom portion 102, 103 of the semielliptical or crescent shaped body 101 extend laterally outwards beyond the inner surface wall 107 to form a top protruding rim 115 and a bottom protruding rim 116. The top and bottom protruding rims 115, 116 are semicircular and preferably correspond to the shape of the outer lip 62 along the rim of the drum 60, with at least a portion of the bottom portion 102 and the hollow pipe 106 of the particulate collector 100 extending out from the drum 60. A second chamber 119 is defined between the top protruding rim 115, a bottom protruding rim 116 and the inner surface wall 107. The second chamber is in communication with the collection chamber 105 via the vacuum ports 108, 109, 110.

The top and bottom portions 102, 103 of the crescent shaped body 101 and the C-shaped sides 104 also form opposed outer curved ends 121 each with outer edges 111. The curve of the outer curved ends 121 aid in maintaining contact between the drum 60 and the particulate collector 100 through friction. The radius of the curve of the outer curved ends 121 also preferably corresponds to a curvature of the outer lip 62 of the rim of the drum 60.

The opposed outer curved ends 121 each contain a slot 112 extending inwards from the outer edge 111. The slots 112 define an opening 113 that contains a stop 114. The openings 113 defined between the slots 114 and the stop 114 are greater in thickness than right and left clips 300, 310 shown in FIGS. 19-24 to allow movement of the clips 300, 310 within the slot and relative to the lip of the drum. Referring to FIGS. 28-31, the left clip 300 has a body 304 with a top surface 303, side surface 301, a bottom surface 305 and a lip 306 extending out axially outwards from the bottom surface 305. The lip 306 is angled such that a leading edge 308 is greater in height than the other edge 309 of the lip 306. The right clip 310 has a body 313 with a top surface 312, side surface 318, a bottom surface 314 and a lip 315 extending out axially outwards from the bottom surface 314. The lip 315 is angled such that a leading edge 317 is greater in height than the other edge 316 of the lip 315.

A funnel shield 117 has a C-shaped dome body 123 attached to or formed integrally with the top portion 103 of the semielliptical or crescent shaped body 101 of the particulate collector 100 at an angle. The C-shaped dome body 123 of the funnel shield 117 has a top outer surface 125, a bottom inner surface 126 and opposed curved outer ends 124. The opposed curved outer ends 124 of the funnel shield 117 extend beyond the top protruding rim 115 and bottom protruding rim 116 to define at least one angled passage 118 which can funnel particulates towards the collection chamber 105 through the holes 128 and to the second chamber 119 with vacuum ports 108, 109, 110. While the funnel shield is shown as extending beyond the top protruding rim 115, a length, the amount of extension and the length of extension from the top protruding rim 115 can vary.

The angle of the angled passage 118 formed between the semielliptical or crescent shaped body 101 of the particulate collector 100 relative to the inner surface wall 107 is approximately 15 degrees. A divider wall 127 can be present within the angled passage 118 between the top portion 103 of the semielliptical or crescent shaped body 101 and the bottom inner surface 126 of the funnel shield 117 to create additional passages. It should be noted that all of the angled passages 118 formed by the semielliptical or crescent shaped body 101 and the funnel shield 117 are funnel particulates to the collection chamber 105 in communication with the vacuum ports 108, 109, 110 through holes 128.

The semielliptical or crescent shaped body 101 of the particulate collector 100 and the funneling shield 117 are preferably symmetric about the centerline C-C.

Referring to FIGS. 26-31, to secure the particulate collector 100 to the drum 60, the particulate collector 100 is placed within the opening 64 of the drum 62 such that the hollow pipe 106 is hanging outside of the drum 60. The left and right clips 300, 310 are then aligned with the outer lip 62 of the drum 60 such that the lips 306, 315 of the clips 300, 310 can slide under the outer lip 62 of the drum 60. Once the lips 306, 315 of the clips 300, 310 are aligned to engage underneath the outer lip 62 of the drum 60, the clips 300, 310 are slid towards the vacuum port 402 within the slots 432, 434, pulling the particulate collector within the drum 60 and angling the particulate collector 400 within the drum 60 for particulate collection.

A vacuum hose 66 has a first end coupled to a vacuum cleaner (not shown) and a second end friction fit onto the second end 106b of the hollow pipe 106. When the vacuum cleaner is turned on, a vacuum is created within the collection chamber 105, the second chamber 119, and angled funnel passage 118 defined by the funnel shield 117 and the top portion 103 of the semielliptical or crescent shaped body 101 and as a result, a downward draft is present over the opening 64 of the drum 60. Any billowing particulates are caught within the downward draft, funneled into the angled funnel passage 118 between the funnel shield 117 and the second chamber 119 directly into the second chamber 119 or into the angled funnel passage 118 and to the collection chamber 105. Billowing particulates are sucked from the second chamber 119 through vacuum ports 108, 109, 110 and into the collection chamber 105, then into the opening 120 of the hollow pipe 106 and into a vacuum container (not shown) of the vacuum cleaner coupled to the vacuum hose 66.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A particulate collector for attachment to a vacuum cleaner and for preventing particulates from spilling over a top of an opening of a drum during mixing of material in the drum, the opening being defined by a rim with an outer lip, the collector comprising:
a body with opposing curved ends, the body having a top portion extending to an upper rim and a bottom portion extended to a lower rim, and an inner wall surface having at least three ports, the top portion, bottom portion and inner wall surface defining a first chamber and the lower rim, upper rim and inner wall surface defining a second chamber, the first chamber being connected to the second chamber through the at least three ports of the inner wall surface;
a hollow pipe having a tubular body with an outer end for attachment to a vacuum cleaner and an inner end mounted to the body and in communication with the first chamber via a port;
a funnel shield mounted to the top portion of the body extending beyond the upper rim and the lower rim of the body, the funnel shield having a funnel body with a top surface, a bottom surface, and curved outer ends, the bottom surface of the funnel shield body and the top surface of the body defining at least one angled passage; and
wherein when the body of the particulate collector is placed in the opening of the drum, the body rests on the rim of the opening, such that when a vacuum cleaner is connected to the outer end of the hollow pipe, particulates which are present in the opening of the drum are sucked into vacuum cleaner.

2. The collector of claim 1, wherein the opposing curved ends of the body are curved to correspond to a curvature of the outer lip of the rim of the drum.

3. The collector of claim 1, wherein an overall shape of the body is semielliptical.

4. The collector of claim 1, wherein the overall shape of the funnel body is C-shaped.

5. The collector of claim 1, further comprising at least one slot formed in each of the curved ends of the body.

6. The collector of claim 5, further comprising at least a first clip and a second clip, each clip being slidably received within a slot formed in a curved end of the body.

7. The collector of claim 6, wherein each clip comprises: a body with a top surface, a side surface, a bottom surface and a lip defined by a first edge and a second edge, the lip extending axially outwards from the bottom surface and angled relative to the bottom surface such that the first edge is extends further axially outwards than the second edge.

8. The collector of claim 7, wherein the slots define an opening that is greater in size than a thickness of the first and second clips.

9. The collector of claim 8, wherein the opening of the slots further comprises a stop that has a thickness equal to the thickness of the first and second clips.

10. The collector of claim 1, wherein the funnel shield is integrally formed with the top portion of the body.

11. The collector of claim 1, further comprising a series of holes in communication with the first chamber.
